(19) United States
(12) Patent Application Publication
(10) Pub. No.: US 2002/0187402 A1
(43) Pub. Date: Dec. 12, 2002

(54) Solid electrolyte and battery using the same

(76) Inventor: Koji Hataya, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/025,324

(22) Filed: Dec. 18, 2001

(30) Foreign Application Priority Data
Dec. 19, 2000 (JP) 2000-386082

(51) Int. Cl. H01M 10/40

(52) U.S. Cl. 429/306; 429/317

(57) ABSTRACT

A solid electrolyte having an electrolyte solution and a crosslinked polymer that is being chemically crosslinked, wherein the electrolyte includes therein a gel phase, in which the crosslinked polymer is swelled with the electrolyte solution, and a separated phrase of electrolyte solution phase. A nonaqueous secondary battery using the above described solid electrolyte.

### FIELD

The present invention relates to a solid electrolyte and a nonaqueous secondary battery using the solid electrolyte.

### BACKGROUND

In recent years, for the purpose of achieving miniaturization and portability for a portable telephone, a video camera, a notebook computer and the like, or of practical use of an electric car, storage batteries having a higher energy density have been needed. Among these, a nonaqueous electrolyte battery has been developed, which is capable of providing an output of 3 V or higher by the use of an electrolyte solution made by dissolving a salt in an organic solvent. A lithium ion secondary battery, which has already been marketed, is its typical example.

For the positive electrode of such a nonaqueous electrolyte battery, spinel structure compounds such as LiMn₂O₄, lithium-containing transition metal composite oxides having an α-NaFeO₂ structure generally designated by LiMO₂, and the like can be used. M represents a single metallic element or two or more kinds of metallic elements selected from Co, Ni, Al, Mn, Ti, Fe and the like. Furthermore, use can also be made, for example, of metal oxides such as MnO₂ or V₂O₅ and metal sulfides such as TiS₂ or ZnS₂ into which lithium can be doped; π-conjugated-type polymers having an electrochemical redox activity such as polyaniline or polypyrrole; and disulfide compounds having a disulfide bond in their molecules, of which formation/cleavage is used.

On the other hand, for the negative electrode, metallic lithium and various lithium alloys, various metal oxides such as SnO₂, or carbon materials capable of doping and undoping lithium can be used. As the carbon materials, naturally occurring graphite, graphite-series carbon materials that are formed by sintering an organic material at a high temperature of 2000° C. or higher so as to have a developed graphite structure and a flat electric potential characteristic, coke-series carbon materials that are formed by sintering an organic material at a relatively low temperature of 1000° C. or lower so that it can be expected to have a larger charge/discharge capacity than graphite-series carbon materials, and the like, can be employed.

As combinations of the positive electrode and the negative electrode in lithium ion secondary batteries that are marketed now, many batteries use lithium-containing transition metal composite oxides such as LiCoO₂ or LiMn₂O₄ for the positive electrode, and various carbon materials for the negative electrode.

For the purpose of improving the electronic conductivity of the electrodes, powdery or fibrous metals or carbon may be added to the above electrodes. As a metal, copper, silver, aluminum and the like can be used. As carbon, graphite, carbon black, acetylene black, ketjen black and the like can be used.

Concerning a method for manufacturing an electrode, a method, which is widely conducted, comprises: obtaining an electrode mixture paste by dispersing various active materials and, if necessary, a conductive assistant composed of a fine powder of carbon or a metal, in a solution of a small amount of a polymer material, for example poly(vinylidene fluoride) (PVDF), which serves as a binder and is dissolved in a solvent such as 1-methyl-2-pyrolidone; applying both surfaces or one surface of a metal foil which is tens of micrometers in thickness and is to be an electrode core material, with the electrode mixture paste; and removing the organic solvent. Examples of other binders include ethylene/propylene/diene terpolymer (EP rubber), various fluororubbers, such as vinylidene fluoride/propylene copolymer and vinylidene fluoride/hexafluoropropylene copolymer, and the like. Other examples of the binders to be used include poly(tetrafluoroethylene) (PTFE), or latexes or dispersions of polymers such as SBR or NBR, to which a water-soluble polymer such as sodium polymethacrylate or carboxymethyl cellulose (CMC), is added as a thickener. Further, an electrode core material is also called a current collector. The current collector can be made often of an aluminum foil for a positive electrode side, and a copper foil for a negative electrode side, in general.

Further, in the case of an electrode just after being applied/dried, evaporation of a solvent in the drying process generates voids in the electrode, whereby the filling factor sometimes becomes too low. This results in weak contact among particles one another in the electrode mixture, thereby providing insufficient electronic conductivity. Therefore, electronic conductivity of an electrode is often improved, by increasing the filling factor of an electrode with the use of a roll press and the like.

A battery is generally manufactured by: winding tightly the positive electrode and negative electrode prepared by the above method so as to make several layers in the form of both electrodes facing each other, through the intermediary of a polymer microporous film to be a separator, so as not to lose their forms; inserting the winded electrodes into a metallic battery can; injecting an electrolyte solution into the metallic battery can; and then finally caulking mechanically, or sealing completely by a method such as laser welding.

A microporous film made of polypropylene or polyethylene is used as a separator. A nonaqueous electrolyte solution in which a lithium salt is dissolved in an organic solvent is generally used as an electrolyte solution. As the organic solvent, ethylene carbonate, propylene carbonate, γ-butyrolactone, sulfolane, diethylcarbonate, dimethylcarbonate, ethylmethylcarbonate, dimethoxyethane, diethoxyethane, 2-methyl-tetrahydrofuran, various glymes, and the like can be used singly or as a mixture of two or more of them. As the lithium salt, because of the high ionic conductivity of the resultant electrolyte solution or because of electrochemical stability in the potential range in which a battery is used, in many cases, lithium hexafluorophosphate (LiPF₆), lithium perchlorate (LiClO₄), lithium tetrafluoroborate (LiBF₄) and the like are mainly used. In addition, in recent years, the use of various imide salts such as bis(trifluoromethylsulfonyl)imide lithium (LiN(CF₃SO₂)₂) have also been studied.

For the above-described nonaqueous electrolyte battery represented by a lithium ion secondary battery, it is desired to have a higher capacity and a longer lifetime. On the other hand, in view of improvements of safety, the degree of freedom on the battery forms, and the like, the use of a solid or solid-like electrolyte has been investigated.

That is to say, in place of an electrolyte solution having fluidity, the use of an electrolyte having ionic conductivity by dissolving a lithium salt in a polymer compound, a gel-like electrolyte having reduced fluidity by keeping an electrolyte solution in a polymer crosslinking structure, or an inorganic ceramic and a glass having ionic conductivity has been investigated. By using such a solid-like electrolyte, a solution leakage can be prevented from the battery, and a battery form itself can be also converted into a film form.

Among these solid or solid-like electrolytes, a use of many gel-like electrolytes containing an electrolyte solution have been investigated, in view of the ionic conductivity at room temperature, film-forming ability, and the like. That is, the operation at room temperature as a battery requires that the ionic conductivity at room temperature should be in the order of 1 mS/cm or a similar value and it should be possible that the electrolytes are allowed to be a thin film. Therefore, it is most realistic at the present time to use gel electrolytes in which an electrolyte solution is fixed with a polymer crosslinking structure.

What comes first as a gel electrolyte is a system in which a straight chain high-molecular-weight polymer is plasticized with an electrolyte solution. That is, it is manufactured by: dissolving the polymer in an electrolyte solution at a high temperature so as to form a film, and subsequently cooling the film down to room temperature, thereby forming a gel; or diluting the combination of a polymer and an electrolyte solution with a low-boiling-point solvent so as to have fluidity, and then forming a film by vaporizing away the low-boiling-point solvent. Although such a system has no chemical crosslinking structure in the polymer, it has an extremely high viscosity, or fluidity of the system is lost because of the physical crosslinking by the partial phase separation between the electrolyte solution and the polymer component. Therefore, the system can be treated substantially as a solid. Specifically known are gel electrolytes comprising a polymer having a relatively high molecular weight, such as polyacrylonitrile, polyethylene oxide, ethylene glycol/propylene glycol copolymer, polymethyl methacrylate, and polyvinylidene fluoride, plasticized with an electrolyte solution. However, these systems have such disadvantages that it is necessary to handle a high viscosity solution in the manufacture, and that the systems are fluidized at a high temperature because they have no chemical crosslinking structures. Further, gelation by physical crosslinking is determined according to very subtle affinity between a polymer component and an electrolyte solution so that possible combinations and compositions are very limited.

Secondly, there is a method comprising polymerizing various (meth)acrylate monomers or vinyl monomers. That is, the method comprises dissolving a monomer having a double bond capable of polymerization in an electrolyte solution, and polymerizing the monomer by the use of heat, light, radiation or a radical initiator. In this method, adding partly a polyfunctional monomer in advance makes it possible to form crosslinking structures in the polymerization reaction so as to lose fluidity, whereby the whole system can be solidified with the electrolyte solution maintained. That is, it is a method for “solidifying as it is” an electrolyte solution. As an example of such a method, there is a method comprising dissolving a monomer of various (meth)acrylic acid ester monomers such as methyl methacrylate and ethyl methacrylate, vinyl acetate, styrene, their derivatives and the like in an electrolyte solution, and then polymerizing the monomer. In this process, an ethylene glycol dimethacrylate, ethylene dimethacrylate and the like which are polyfunctional monomers are coexisted and the monomers are copolymerized, whereby crosslinking structures are formed, and therefore the whole system loses fluidity. Besides, a method comprising polymerizing macromonomers such as polyethylene glycol ethyl ether methacrylate and polyethylene glycol dimethacrylate in an electrolyte solution is known. In addition, as the polymerization methods, there are photopolymerization by means of ultraviolet or electron beam irradiation, and thermal polymerization in the presence of a radical initiator such as dibenzoyl peroxide and azobisisobutyronitrile.

Moreover, there is a similarly method comprising solidifying the whole system by forming crosslinking structures by the use of polyaddition-type chemical reactions such as urethanization and an epoxidation reaction.

When a solid electrolyte is prepared by the polymerization method or the chemical crosslinking method, it is not always necessary to handle a high viscosity solution. Further, the resulting electrolyte is excellent in not only stability and liquid-maintaining ability because the electrolyte is solidified in the final form, but also heat resistance because the electrolyte has chemical crosslinking structures. Furthermore, an electrolyte film that is thin and has a high mechanical strength can be obtained, by impregnating a porous substance or nonwoven fabrics, with an undiluted solution of the electrolyte in advance, and then solidifying the electrolyte.

Besides, there is another method comprising preparing a film in advance with a polymer having a strong affinity for an electrolyte solution, and then swelling the film with an electrolyte solution, thereby providing ionic conductivity. The method has been specifically investigated on systems such as poly(vinylidene fluoride)-series copolymer, and acrylonitrile/butadiene rubber. In these systems, the polymer film may be allowed to be porous or crosslinked in advance, considering increase in film strength or volume change after swelling. These systems have such problems that it has a poor liquid-maintaining ability so that the electrolyte solution is exuded with the lapse of time, because the film is impregnated with the electrolyte solution afterwards.

Concerning the solid electrolyte such as gel electrolyte produced as described above, it has been generally acknowledged that those with higher ionic conductivity are better. However, what is actually important is not merely performance of electrolyte itself but performance of a battery when the solid electrolyte is incorporated therein. However, when the conventional solid electrolyte described above is used, the performance of the obtained battery is not always satisfactory.

### SUMMARY

The present invention is a solid electrolyte, which comprises an electrolyte solution and a crosslinked polymer that is chemically crosslinked, wherein the electrolyte includes therein a gel phase, in which the crosslinked polymer is swelled with the electrolyte solution, and a separated phase of electrolyte solution phase.

Further, the present invention is a method of producing the above-described solid electrolyte, which comprises forming a phase-separated structure by increasing, in a relationship between a mass ratio of an amount of electrolyte solution/crosslinked polymer and a crosslink density, the crosslink density or the mass ratio of electrolyte solution/crosslinked polymer, to be in or over a range in which the electrolyte solution can be contained in a polymer chain.

Further, the present invention is a nonaqueous secondary battery, which uses the solid electrolyte.

Further, the present invention is a method of producing a nonaqueous secondary battery, which comprises the steps of: assembling a positive electrode, a negative electrode and a separator into a final battery form, and performing the above-described method of producing the solid electrolyte.

Other and further features and advantages of the invention will appear more fully from the following description, taken in connection with the accompanying drawings.

### BRIEF DESCRIPTION OF THE DRAWINGS

FIGS. 1(A) and 1(B) are optical microphotographs each showing a solid electrolyte. FIG. 1(A) shows a conventional solid electrolyte, and FIG. 1(B) shows a solid electrolyte of the present invention.

FIGS. 2(A) and 2(B) are views illustrating a film-type lithium ion battery. FIG. 2(A) is a perspective view, and FIG. 2(B) is a partially enlarged cross-sectional view.

FIG. 3 is a cross-sectional view showing an example of a cylindrical battery.

### DETAILED DESCRIPTION

According to the present invention, an electrolyte can be obtained which gives a battery having very excellent characteristics when the electrolyte is actually incorporated in a battery, by controlling microstructure of a gel electrolyte, more specifically by causing partial phase separation of an electrolyte solution phase inside the electrolyte, to impart the gel electrolyte with a dispersion structure of the fine electrolyte solution phase in the gel electrolyte. In the present invention, as shown hereinbelow, it has been found that for the performance of a battery in which a solid electrolyte has been actually incorporated, not only values of ionic conductivity and the like of the solid electrolyte itself but also microstructure of the solid electrolyte are very important.

According to the present invention, there are provided the following means (1) to (10):

(1) A solid electrolyte, comprising an electrolyte solution and a crosslinked polymer that is chemically crosslinked, wherein the electrolyte includes therein a gel phase, in which the crosslinked polymer is swelled with the electrolyte solution, and a separated phrase of electrolyte solution phase;

(2) The solid electrolyte according to the above item (1), wherein in the phase-separated structure, the electrolyte solution phase has a size of less than 20 μm;

(3) A method of producing the solid electrolyte according to the above item (1) or (2), comprising forming a phase-separated structure by increasing, in view of a relationship between a mass ratio of an amount of electrolyte solution/crosslinked polymer and a crosslink density, the crosslink density or the mass ratio of electrolyte solution/crosslinked polymer, to be in or over a range in which the electrolyte can be contained in a polymer chain;

(4) The method of producing the solid electrolyte according to the above item (3), wherein the solid electrolyte is prepared, by dissolving a low molecular weight compound that is polymerizable by using heat, an optical polymerization initiator or the like in the electrolyte solution in advance, and subjecting the resultant solution to polymerization reaction to form a crosslinked polymer;

(5) The method of producing the solid electrolyte according to the above item (3) or (4), wherein the degree of crosslinking of the crosslinked polymer is controlled by a combination of a low molecular weight compound having a single reaction point and a low molecular weight compound, which functions as a crosslinking agent, having two or more reaction points;

(6) The method of producing the solid electrolyte according to the above item (5), wherein a homopolymer of the low molecular weight compound having a single reaction point contains a low molecular weight compound that is soluble in the electrolyte solution;

(7) The method of producing the solid electrolyte according to any one of the above items (4) to (6), wherein a (meth)acrylate monomer as the polymerizable low molecular weight compound is used;

(8) The method of producing the solid electrolyte according to the above item (5), wherein ethylene dimethacrylate as the low molecular weight compound functioning as the crosslinking agent is included;

(9) A nonaqueous secondary battery comprising the solid electrolyte according to the above item (1) or (2); and

(10) A method of producing a nonaqueous secondary battery, comprising the steps of: assembling a positive electrode, a negative electrode and a separator into a final battery form, and performing the method of producing the solid electrolyte according to any one of the above items (3) to (8).

Note that in the present invention, a phase-separated state of an electrolyte solution phase refers to a state where inside the electrolyte, there exist a portion in which crosslinked polymer is swelled with the electrolyte solution (gel phase) and, separately therefrom, an electrolyte solution phase that is not included in the crosslinked polymer. Such an electrolyte is clearly different from an electrolyte composed solely of a gel phase in which an electrolyte solution is retained in a crosslinked polymer.

The solid electrolyte of the present invention is a solid electrolyte consisting of a nonaqueous electrolyte solution containing a lithium salt, for example, and a crosslinked polymer. A nonaqueous secondary battery of the present invention using the solid electrolyte as described above includes, for example, a lithium ion battery.

According to the present invention, it is possible to produce an electrolyte having a microstructure in which the electrolyte solution phase has partially undergone micro phase separation inside the electrolyte, and to produce a high performance leakage-free battery by the use of such an electrolyte. As will be described in detail in Example and below, the use of electrolyte having a phase-separated structure enables production of a battery having overwhelmingly superior characteristics as compared with a battery with a uniform phase gel electrolyte, although such an electrolyte has ionic conductivity that is substantially equal or inferior to that of the uniform phase gel electrolyte.

When observed with naked eye, the conventional uniform phase gel electrolyte has a transparent outward appearance. On the other hand, the electrolyte of the present invention has an opaque outward appearance, and it is an electrolyte having a structure such that a partially phase-separated phase of an electrolyte solution is present inside the electrolyte that is the subject of the present invention.

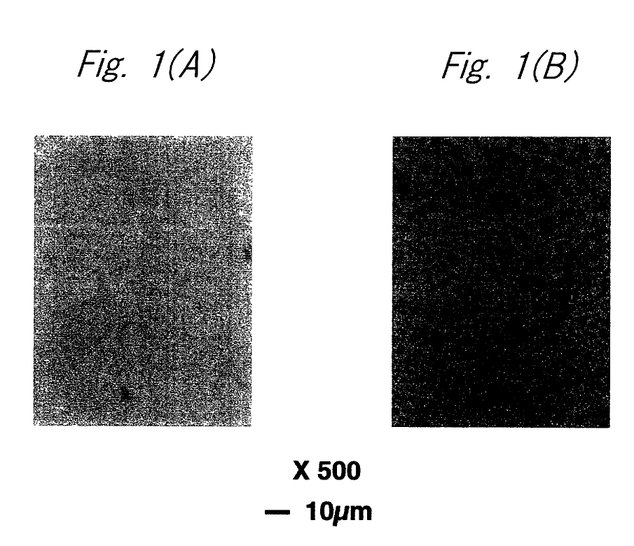

Now, reference is made to the microphotographs of FIGS. 1(A) and 1(B). In the opaque electrolyte in FIG. 1(B), a structure was observed in which clear phase separation occurred between a gel phase that looks whitish and an electrolyte solution phase of an order of micro meter that looks slightly blackish. On the other hand, in the conventional transparent gel electrolyte of FIG. 1(A), no such phase separation structure was observed.

The electrolyte itself used in the present invention is the same as ordinary one, and its components and composition are not particularly different therefrom. More specifically, as described above, usually a nonaqueous electrolyte solution in which a lithium salt is dissolved in an organic solvent is used. As the organic solvent, ethylene carbonate, propylene carbonate, γ-butyrolactone, sulfolane, diethyl carbonate, dimethyl carbonate, ethyl methyl carbonate, dimethoxyethane, diethoxyethane, 2-methyltetrahydrofuran, various glymes and the like may be used singly or as mixtures of two or more of them. As the lithium salt, because of high ionic conductivity of the resultant electrolyte solution, or because of electrochemical stability in the potential range in which a battery is used, in many cases lithium hexafluoro phosphate (LiPF₆), lithium perchlorate (LiClO₄), lithium tetrafluoroborate (LiBF₄), and the like are mainly used. In addition, in recent years, a use of various imide salts such as lithium bis(trifluoromethylsulfonyl)imide (LiN(CF₃SO₂)₂) has also been studied.

Hereinafter, the electrolyte having a special microstructure of the present invention will be described.

Not only in gel electrolyte but also in general uniform phase gels, liquid is contained in the molecular chain of crosslinked polymer on the molecular level. That is, inside the gel, crosslinking chains and liquid that are compatible with each other are mixed on the molecular level and crosslinking points are present on the crosslinking chains to provide a network structure, so that the flowability of the liquid is restricted.

Here, generally, when decreasing the size of the network of the crosslinked polymer, the amount of liquid that can be retained in the crosslinked polymer is decreased. That is, the amount of liquid that can be retained in the gel chain is inversely proportional to the crosslink density.

In the case of a method of preparing gel electrolyte by a polymerization method or chemical crosslinking method, which is a method for “gelation” of the electrolyte as described above, usually transparent uniform phase gel is produced. However, for example, as the crosslink density of crosslinked polymer formed by the use of the electrolyte solution is increased, a situation may occur where that the crosslinked polymer produced by the gelation reaction can no longer include the electrolyte solution in the network of the molecular chain. If the electrolyte solution is “gelled” in such a state, solidification reaction will proceed and, as crosslinked polymer is formed, the electrolyte solution undergoes phase separation. Here, in the case where the solidification speed is extremely slow or in other such case, the electrolyte solution phase and gel phase may become completely (macroscopically) separated. On the other hand, when the solidification speed is sufficiently fast such that the solidification is completed within the time range of several minutes to several hours, for example, the electrolyte solution phase undergoes micro phase separation in the bulk of the electrolyte, so that there is obtained an electrolyte that is in a solid state as a whole but includes therein an electrolyte solution phase that has been phase-separated. The more preferable solidification speed is such that allows the solidification to complete in the range of 1 minute to 2 hours. Here, however, the “gel phase” refers to a phase in which electrolyte solution is included on the molecular level in the network of molecular chain of crosslinked polymer. It is conceived that the electrolyte having a microstructure as shown in FIG. 1(B) can be synthesized in the manner as described above.

Concerning the microstructure of electrolyte, the gel phase must be continuous since it constitutes the skeleton of an electrolyte. On the other hand, the phase-separated electrolyte solution phase may be either independent or continuous. The size of the phase-separated electrolyte solution phase may be on the order of 10 μm or less, that is, preferably less than 20 μm, and more preferably 0.1 to 10 μm. The lower limit should exceed the molecular level. On the other hand, if the size of individual electrolyte solution phase is too large, there may arise the problem of macroscopic sweat out of electrolyte solution. However, because the electrolyte of the present invention is not simply a sponge in which the electrolyte solution and crosslinked polymer are completely isolated, it still has good liquid retaining property as the bulk, although partially phase-separated.

It can be said that according to the present invention, the electrolyte having a phase-separated structure is synthesized by controlling the crosslink density. Control of crosslink density is achieved as follows. For example, in the case where the crosslinked polymer is formed by polymerizing low molecular weight compound to which an electrolyte is added, a monomer having a single reaction point (that is, monomer that gives a straight chain polymer upon homopolymerization) and a monomer having two or more reaction points functioning as a crosslinking agent are combined and their ratio is varied to thereby readily change the crosslink density of the crosslinked polymer thus formed. For example, in the case of the combination of methyl methacrylate and ethylene dimethacrylate as shown in Example of the present invention, an increased ratio of ethylene dimethacrylate results in an elevated crosslink density of the crosslinked polymer. Note that although it is possible to vary crosslink density by varying the molecular weight of the monomer having two or more reaction points, the former method using the combination of a monomer having a single reaction point and a crosslinking agent allows control for much wider range, including control of the range of crosslink density, chemical structure of polymer chain and the like.

However, there is no particular limitation for the range of crosslink density. This is because whether or not phase separation occurs is determined on the relationship between affinity of the electrolyte solution for crosslinked polymer and crosslink density. That is, in the case where the affinity of the electrolyte solution for the gel chain is low, phase separation takes place at a relatively low crosslink density. On the contrary, in the case where the affinity of the electrolyte solution for the crosslinked polymer is high, the crosslink density must be increased in order to occur phase separation. Also, when the crosslink density is identical, the phase separation of the electrolyte solution phase can take place by using greater amount of electrolyte solution relative to the crosslinked polymer.

Furthermore, in principle, the higher the crosslink density, the greater the amount of phase-separated electrolyte solution phase. However, as the crosslink density increases, the electrolyte will become mechanically more fragile. For example, in the case of the combination of methyl methacrylate and ethylene dimethacrylate, if the ratio of ethylene dimethacrylate contained in monomer material exceeds 50 wt %, a very fragile electrolyte is obtained, which is not quite suitable for use in a battery.

As for the material which can be used, an example of gel electrolyte formed by the use of the combination of methyl methacrylate and ethylene dimethacrylate has been presented herein. However, the scope of the present invention is not limited thereto. That is, although in the case of a straight chain polymer obtained by dissolving it in the electrolyte solution while it is still in the state of monomer or by polymerization of monomer having a single reaction point, the polymer must be soluble in the electrolyte solution when it is in an uncross-linked state, in other respects there is no limitation. For example, it may be easily conceived that, even if methyl methacrylate is replaced by methyl acrylate or ethyl methacrylate, electrolyte having similar characteristics can be obtained. Furthermore, the monomer having a single reaction point is not necessary be one kind but two or more kinds of monomers may be combined. Similarly, as the crosslinking agent, a mixture of plural kinds of crosslinking agents may be used instead.

However, those materials containing a polyalkylene oxide structure such as polyethylene oxide is not desirable for use in the electrolyte of the present invention since they have very strong interaction with lithium salts so that phase separation of electrolyte solution is difficult to occur.

Note that in the present invention, when actually assembling a battery, it is preferable that the battery is assembled according to the same procedure as performed in the production of a battery with an electrolyte solution; that is, an electrolyte film is not prepared in advance but instead an undiluted solution of electrolyte before it is solidified is injected into cells of the battery finally assembled into a battery system and solidified in that state. In this case, however, if a macro monomer which has a large molecular weight is used, the viscosity of the undiluted solution of electrolyte increases, so that it becomes difficult to inject the undiluted solution of electrolyte into pores of electrode or battery. Therefore, the monomer contained in the undiluted solution of electrolyte has a molecular weight of preferably 400 or less, or more preferably, 200 or less.

The nonaqueous secondary battery of the present invention is the same as ordinary nonaqueous secondary battery except that the solid electrolyte of the present invention is used, and regarding the production method thereof, such a battery can be produced by the conventional production method except that it includes steps for producing the solid electrolyte of the present invention.

The nonaqueous secondary battery of the present invention has high discharge capacity and enhanced capability of maintaining discharge capacity. Further, the solid electrolyte of the present invention is suitable for use in such a nonaqueous secondary battery.

The solid electrolyte of the present invention is a solid electrolyte directly contributing to improved performance of a battery.

The solid electrolyte of the present invention enables very simple production of a battery that has excellent battery characteristics.

Further, according to the method of producing a solid electrolyte of the present invention, a solid electrolyte that can realize excellent battery performance can be produced.

Still further, according to the present invention, a secondary battery having excellent characteristics can be provided by the use of the solid electrolyte as described above.

Still furthermore, the method of producing a nonaqueous secondary battery of the present invention is suitable as a method of producing the above-mentioned secondary battery having excellent characteristics.

As will be apparent from the description herein, the use of the technique according to the present invention, that is, the use of the electrolyte of the present invention in which electrolyte solution phase that has undergone micro phase separation is present within the electrolyte enables production of a battery having very high performance. Further, the electrolyte of the present invention has good thermal stability since it has chemically crosslinked structure. Furthermore, application of the technology of the present invention to a battery already assembled into a final battery form, for example, a flat battery or a battery having a spiral structure, and the like, enables production of a leakage-free battery without substantially modifying the conventional method of producing a battery by the use of an electrolyte solution. Also, by the use of such a method, even a large battery can be readily rendered free of leakage.

The present invention will be described in more detail based on examples given below. Further, for clarifying the effect of the present invention, a comparative example is also shown. However, the present invention is not limited to these examples.

### EXAMPLES

In the following example and comparative example, not only tests of electrolyte but also tests of a flat battery and a cylindrical battery having an internal spiral structure being actually fabricated were performed.

### Examples

1. Preparation of an Undiluted Solution of an Electrolyte

Methyl methacrylate monomer (hereinafter, referred to as MMA) and ethylene dimethacrylate (hereinafter, referred to as EdMA) as a crosslinking agent were mixed as appropriate and a monomer mixture containing the both components in a mass ratio of 97.5:2.5 to 70:30 was provided. Further, a propylene carbonate solution having dissolved therein 1 M LiClO₄ was provided as an electrolyte solution. The monomer mixture and the electrolyte solution were mixed with each other so as to have a mass ratio of 20:80. Finally, 1,000 ppm of azobisisobutyronitrile as a polymerization initiator was added thereto to form a undiluted solution of electrolyte. Note that in the case of the monomer mixture in which MMA:EdMA ratio is 97.5:2.5, a mixture of the monomer mixture and the electrolyte solution in a mass ratio of 15:85 was provided, while in the case of the monomer mixture in which MMA:EdMA ratio is 70:30, a mixture of the monomer mixture and the electrolyte solution in a mass ratio of 25:75 was provided. The composition of the undiluted solution of electrolytes thus prepared is summarized in Table 1 (Nos. 1 to 7).

Note that preparation of the undiluted solution of the electrolyte and subsequent manipulations were all performed in a dry air of which dewpoint was −60° C. or lower in atmosphere of argon.

2. Fabrication of a Film Consisting of the Electrolyte Alone

Silicone rubber of a thickness of 1 mm with a cutout in the center as a spacer was sandwiched between two glass plates and the periphery thereof was fixed with clips to form a mold for fabricating an electrolyte film. Subsequently, the above undiluted solution of the electrolyte was injected into the mold with a syringe. This was placed in a sealed vessel and heated at 80° C. for 2 hours to solidify the undiluted solution of the electrolyte to obtain a film consisting of the electrolyte alone having a thickness of 1 mm.

3. Measurement of Ionic Conductivity

An ionic conductivity of above film consisting of the electrolyte alone was measured. Specifically, the film consisting of the electrolyte alone which was cut out in a diameter of 16 mm was sandwiched by stainless electrodes of 15 mm in diameter and the ionic conductivity thereof was measured by a complex impedance method by the use of an electrochemical measuring apparatus SI-1260, produced by Solartron, Ltd. Assuming that the real part of a resistance value at 20 kHz was a resistance based on ionic conductivity of a sample, then ionic conductivity was calculated from that value.

The results of measurements are summarized in Table 1.

4. Observation of a Texture of the Electrolyte

The electrolytes fabricated as described above showed great differences regarding their appearances. That is, the one having a low EdMA ratio and a low degree of crosslinking was transparent, while the one having a high EdMA ratio and a high degree of crosslinking was opaque.

To clarify these differences, the microstructures of the electrolytes were observed. FIG. 1(A) and FIG. 1(B) are photographs (magnification: ×500) of the micromixture observed by an optical microscope. Specifically, the microstructures of the electrolyte having a ratio of polymer component in the electrolyte of 20% and an MMA:EdMA ratio of 97.5:2.5 as a transparent electrolyte (FIG. 1(A)), and an MMA:EdMA ratio of 70:30 as an opaque electrolyte (FIG. 1(B)) are shown. In FIG. 1(B), the size of electrolyte solution phase in the phase separate structure was approximately 1 to 10 μm.

5. Fabrication of a LiCoO₂ Positive Electrode

900 g of LiCoO₂ (produced by Nikko Fine Products Co., Ltd.) as an active material, 70 g of graphite powder (produced by Lonza Ltd., trade name KS-6) as a conducting agent, and 30 g of PVDF as a binder were mixed and stirred together with 420 g of 1-methyl-2-pyrolidone to prepare an electrode mixture paste. The paste was applied to one side of an aluminum foil in thick of 30 μm by the use of a doctor blade method such that the electrode mixture after drying had a mass of 20 mg/cm², and heated at 100° C. to dissipate 1-methyl-2-pyrolidone. Further, as for the electrode for a cylindrical battery, the electrode mixture paste was applied to the other side of the electrode in the same manner to provide an electrode mixture layer. Thereafter, by compression molding by the use of a roll press machine, a LiCoO₂ positive electrode was fabricated. The LiCoO₂ positive electrode fabricated by this method is called simply as a positive electrode in the following example.

In actually fabricating cells of battery, in the case of a flat battery, a electrode having a size of 30×30 mm obtained by partially peeling off the electrode mixture in a one-side applied positive electrode to make a tab was used. On the other hand, in the case of a cylindrical battery, a positive electrode was used, which was obtained by cutting the positive electrode of an electrode whose both surfaces were applied to a size of 39 mm×400 mm, peeling off the electrode mixture on the both sides at the end portion in a diameter of 7 mm, and welding an aluminum sheet in a thickness of 50 μm and a size of 5 mm×70 mm as an electrode tab in this portion by the use of an ultrasonic welding machine.

6. Fabrication of a Carbon Negative Electrode

930 g of amorphous carbon material (produced by Mitsubishi Chemical, Inc., trade name MBC-NC) as an active material and 70 g of PVDF as a binder were mixed and stirred together with 800 g of 1-methyl-2-pyrolidone to prepare an electrode mixture paste. The paste was applied to one side of a copper foil in a thick of 20 μm by the use of a doctor blade method such that the electrode mixture after drying has a mass of 10 mg/cm, and heated at 100° C. to dissipate 1-methyl-2-pyrolidone. As for the electrode for a cylindrical battery, the electrode mixture paste was applied to the other side of the negative electrode in the same manner to provide an electrode mixture layer. Thereafter, by compression molding by the use of a roll press machine, a carbon electrode was fabricated. The carbon electrode fabricated by this method is called simply as a negative electrode in the following example.

In actually fabricating cells of battery, in the case of a flat battery, a electrode having a size of 31×31 mm obtained by partially peeling off the electrode mixture in a one-side applied negative electrode to make a tab was used. On the other hand, in the case of a cylindrical battery, a positive electrode which was obtained by cutting the positive electrode of an electrode whose both surfaces were applied to a size of 40 mm×430 mm, peeling off the electrode mixture on the both sides at the center in a diameter of 7 mm, and welding a nickel sheet in a thickness of 50 μm and a size of 5 mm×70 mm as an electrode tab in this portion by the use of an ultrasonic welding machine.

7. Fabrication of a Flat Battery

Upon fabrication of a flat battery, first an integral battery cell was fabricated.

In a glass bottle, 2.5 g of a PVDF powder having an average particle diameter of 6 μm (produced by Daikin Industries, Ltd., trade name VP850) and 47.5 g of ethanol were mixed, and ultrasonic wave was irradiated in an ultrasonic cleaner, thereby dispersing the PVDF powder. This PVDF powder dispersion liquid was taken into a laboratory glass dish, and a hydrophilic PTFE microporous membrane (produced by Nihon Millipore Ltd., trade name JGWP membrane filter), which was cut out in a size of 35 mm×35 mm, was soaked in the dispersion liquid, thereby wetting the both surfaces of the membrane to attach the PVDF powder to the both surfaces of the membrane. After that, the membrane was taken out, and was interposed between the positive electrode and the negative electrode for a one-side applied flat battery, and then the membrane and the electrodes were fixed from the both sides with glass plates. After heating at 60° C. and conducting vacuum drying to vaporize ethanol away, the resulting membrane and the electrodes were heated in a stream of nitrogen at 200° C. for 10 minutes to fuse the PVDF powder, whereby the hydrophilic PTFE microporous membrane and the positive electrode and negative electrode were adhered, to manufacture a battery cell in which the positive electrode/diaphragm/negative electrode were completely unified.

Next, the electrolytes undiluted solution Nos. 1 to 7, of which the composition are shown in Table 1, were injected into the inside of an integrated battery cell under reduced pressure, respectively. That is, the integrated battery cell manufactured by the above method was placed in a pressure-resistant vessel, and the whole system was evacuated to about 100 kPa by the use of a dry vacuum pump, and then the electrolyte undiluted solution was introduced so that the battery cell was completely soaked in the solution, and the system was allowed to stand for 3 minutes under reduced pressure, and then the system was brought back to ordinary pressure and was allowed to stand for 10 minutes, whereby the electrolyte undiluted solution was injected into the inside of the integrated battery cell. Then, the battery cell was taken out from the vessel, and the battery cell was enclosed with a fairly large bag made of an aluminum laminated sheet so as to enclose even the terminal portions completely. In this situation, the bag was heated at 80° C. for 2 hours, thereby solidifying the electrolyte undiluted solution (hereinafter, referred to as solid electrolytes Nos.1 to 7).

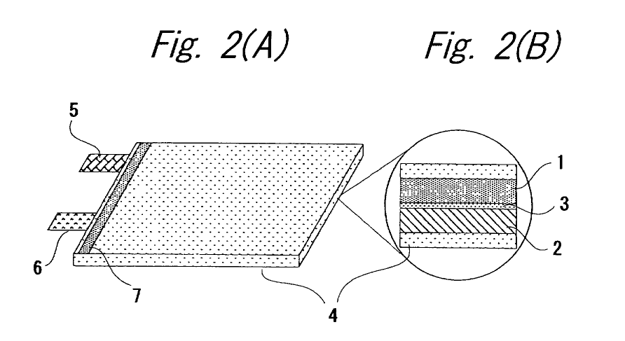

Like this, after solidifying the electrolyte undiluted solution, the battery cell was taken out from the bag, and then it was confirmed that the electrolyte was solidified. Then, after removing the excess electrolyte on the surface of the battery cell, finally the battery cell was included under reduced pressure in the sheielding (package) film made of an aluminum laminated sheet in the form of pulling out the terminal portions shown in FIG. 2, whereby the film-type lithium ion batteries were produced.

FIG. 2(A) shows a perspective view illustrating the film-type lithium ion secondary battery using the battery cell. As shown in FIG. 2(B) in an enlarged cross-section, a shielding (package) film 4 made of aluminum laminate sheet (film) consists of a LiCoO₂ positive electrode 1, a carbon negative electrode 2, and a battery separator (film) 3, and by incorporating the battery cell impregnated with the electrolyte solution therein under reduced pressure, a film-type lithium ion secondary battery is formed. In FIGS. 2(A) and 2(B), 5 represents a positive electrode tab, 6 represents a negative electrode tab, and 7 represents a heat-bonded sealed inlet. Table 1 shows results of charge/discharge cycle tests performed on this electrode structure in Examples and Comparative Example.

8. Fabrication of a Cylindrical Battery

The electrode of a double-applied cylindrical battery was group-wound via polyolefin-made separator (produced by Hoechst AG, trade name CELL GUARD #2400) and the group-wound battery core was inserted in a battery can, with spot-welding the electrode tab for the negative electrode to the battery can and the electrode tab for the positive electrode to the lid. Before caulking the lid, the electrolyte undiluted solutions Nos. 9 and 10 having the compositions shown in Table 2 were injected, respectively. The injection was performed under reduced pressure the same as in the case of a flat battery. After the injection, the battery can and lid were caulked via resin-made packing to seal them to fabricate an AA size battery. Finally, the battery was heated at 80° C. for 2 hours to solidify the electrolyte undiluted solution inside thereof.

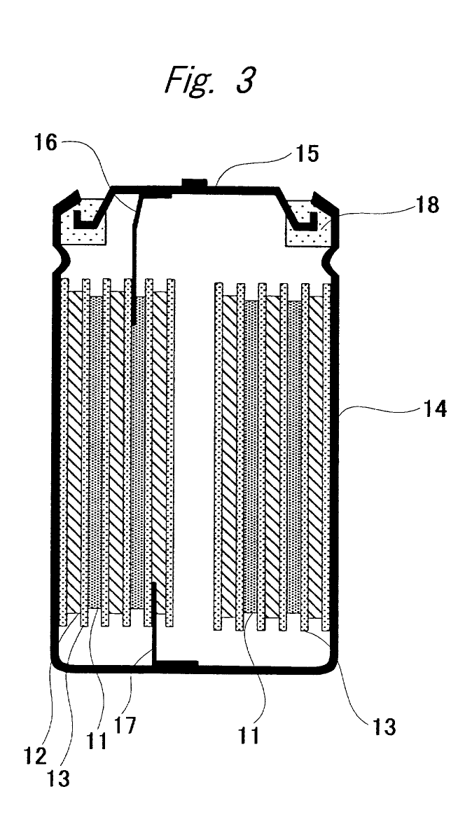

FIG. 3 shows a cross-sectional view showing an example of the cylindrical battery thus fabricated. In FIG. 3, 11 represents a LiCoO₂ positive electrode, 12 represents a carbon negative electrode, and 13 represents a polyolefin-made separator. The electrode having the structure is equipped as a group in a battery can 14. 15 represents a lid of the battery, 16 represents a positive electrode tab, and 17 represents a negative electrode tab. 18 represents a resin-made packing between the battery can 14 and the lid 15.

9. Test Method for Charge/Discharge Cycle

The charge/discharge cycle tests were performed in an incubator at 25° C. In the case of a flat battery, the upper limit voltage was set to 4.2 V and charging was performed at a maximum current of 6 mA for 5 hours, and after 15 minutes' nonoperating time, discharge was performed at a constant current of 6 mA until the battery voltage reached 2.7 V. After the discharging, 15 minutes' nonoperating time was provided before next charging was initiated. This charge/non-operation/discharge/non-operation process was taken as 1 cycle and the cycle was repeated.

On the other hand, in the case of a cylindrical battery, the maximum current upon charging and the current upon discharging were changed to 100 mA, respectively but other conditions such as voltage and time were the same as in the case of a flat battery.

Tables 1 and 2 summarize the results of charge-discharge cycle tests.

### Comparative Example

In place of the gel electrolyte in the Example above, an electrolyte solution (No. 8) consisting of propylene carbonate solution dissolved in 1 M LiClO₄ alone was injected in the battery cell and enclosed under reduced pressure in a shielding (package) film made of aluminum laminate sheet such that terminal portions thereof were taken out as shown in FIG. 2(A) to thereby fabricate a flat battery. Similarly, a cylindrical battery was fabricated by injecting the electrolyte solution only (No. 11), and charge/discharge cycle tests were performed.

TABLE 1
Flat battery

| | Monomer | | | | | Discharging | | |
|---|---|---|---|---|---|---|---|---|
| | compounding | | Polymer | | Ionic | capacity (mAh) | | |
| | ratio (wt %) | | ratio | Appearance of | conductivity | 3 | 20 | 50 |
| No. | MMA | EdMA | (wt %) | electrolyte | (mS/cm) | cycles | cycles | cycles |
| 1 | 97.5 | 2.5 | 20 | Transparent | 1.5 | 13.2 | 6.3 | 4.2 |
| 2 | 95 | 5 | 20 | Transparent | 1.4 | 14.5 | 10.7 | 6.7 |
| 3 | 90 | 10 | 20 | Slightly opaque | 1.6 | 17.8 | 13.6 | 10.4 |
| 4 | 80 | 20 | 20 | Opaque | 1.5 | 19.5 | 18.6 | 18.0 |
| 5 | 70 | 30 | 20 | Opaque | 1.4 | 19.6 | 18.9 | 17.9 |
| 6 | 97.5 | 2.5 | 15 | Transparent | 2.7 | 19.4 | 15.6 | 12.5 |
| 7 | 70 | 30 | 25 | Opaque | 1.0 | 18.6 | 17.4 | 16.1 |

| | | | | | | |
|---|---|---|---|---|---|---|
| 8 | Electrolyte only | — | 5.6 | 20.1 | 19.4 | 18.9 |

TABLE 2
Cylindrical battery

| | Monomer | | | | | Discharging | | |
|---|---|---|---|---|---|---|---|---|
| | compounding | | Polymer | | Ionic | capacity (mAh) | | |
| | ratio (wt %) | | ratio | Appearance of | conductivity | 3 | 20 | 50 |
| No. | MMA | EdMA | (wt %) | electrolyte | (mS/cm) | cycles | cycles | cycles |
| 9 | 97.5 | 2.5 | 20 | Transparent | 1.5 | 230 | 92 | 53 |
| 10 | 70 | 30 | 20 | Opaque | 1.4 | 339 | 329 | 313 |

| | | | | | | |
|---|---|---|---|---|---|---|
| 11 | Electrolyte only | — | 5.6 | 350 | 343 | 336 |

Tables 1 and 2 shows characteristics of the electrolytes fabricated in the Examples and Comparative Example and results of cycle tests using them.

On the above results, first referring to Nos. 1 to 5 of Table 1, it can be said that substantially the same results were obtained with respect to ionic conductivity of electrolyte alone. That is, with the same crosslinked polymer component and the same electrolyte ratio, the substantially same results were obtained with respect to the ionic conductivity of electrolyte itself as a bulk, irrespective of the crosslink density.

However, the performance of batteries using the electrolytes varied greatly. That is, as in No. 1 and No. 2, the batteries using electrolytes that had low crosslink density and were transparent, suggesting occurrence of no phase separation therein showed very poor characteristics. On the other hand, as in No. 4 and No. 5, batteries using electrolytes that were opaque and underwent phase separation showed high discharging capacity in the initial 3rd cycle and considerably good ability of maintaining discharging capacity until the subsequent 20th to 50th cycles. As stated above, in spite of using electrolytes having substantially the same ionic conductivity, battery characteristics varied very greatly.

In the case of No. 6, i.e., uniform phase gel having a low degree of crosslinking and an increased electrolyte ratio, the ionic conductivity was higher than Nos. 1 to 5. However, the battery using No.6 electrolyte showed relatively high discharging capacity at the 3rd cycle, but a drastic decrease in discharging capacity accompanying the charge/discharge cycle.

Further, in the case of No. 7 electrode, although it had a high polymer ratio and low ionic conductivity, it had a high degree of crosslinking and was opaque, thus indicating that phase separation occurred. The battery using this electrolyte showed a somewhat low discharging capacity at the initial 3rd cycle, but clearly improved ability of maintaining discharging capacity accompanying the charge/discharge cycle as compared with No. 1, No. 2 or No. 6, in which uniform phase gel was used.

Next, from the results of Nos. 9 to 11 of Table 2, it can be seen that in cylindrical batteries, as the same in flat batteries, the use of the phase-separated electrolyte of the present invention enabled production of a high-performance, leakage-free battery. In this case, there was no need for substantially modifying the production process of the battery using an ordinary electrolyte solution except for finally heating the battery.

From the above results, it has revealed that for the performance of a battery, not only merely ionic conductivity of a single electrolyte but also microstructure thereof was extremely important. That is, the electrolyte of the present invention, in which an electrolyte solution phase having undergone micro phase separation therein was overwhelmingly superior to ordinary uniform phase gel electrolytes when practically used in a battery, so that the electrolyte of the present invention can be said to be very useful.

Having described our invention as related to the present embodiments, it is our intention that the invention not be limited by any of the details of the description, unless otherwise specified, but rather be construed broadly within its spirit and scope as set out in the accompanying claims.

What is claimed is:

1. A solid electrolyte, comprising an electrolyte solution and a crosslinked polymer that is being chemically crosslinked, wherein the electrolyte includes therein a gel phase, in which the crosslinked polymer is swelled with the electrolyte solution, and a separated phrase of electrolyte solution phase.

2. The solid electrolyte according to claim 1, wherein in the phase-separated structure, the electrolyte solution phase has a size of less than 20 μm.

3. A method of producing the solid electrolyte according to claim 1, comprising forming a phase-separated structure by increasing, in view of a relationship between a mass ratio of an amount of electrolyte solution/crosslinked polymer and a crosslink density, the crosslink density or the mass ratio of electrolyte solution/crosslinked polymer, to be in or over a range in which the electrolyte can be contained in a polymer chain.

4. The method according to claim 3, wherein in the phase-separated structure, the electrolyte solution phase has a size of less than 20 μm.

5. The method according to claim 3, wherein the degree of crosslinking of the crosslinked polymer is controlled by a combination of a low molecular weight compound having a single reaction point and a low molecular weight compound, which functions as a crosslinking agent, having two or more reaction points.

6. The method according to claim 5, wherein a homopolymer of the low molecular weight compound having a single reaction point contains a low molecular weight compound that is soluble in the electrolyte solution.

7. The method according to claim 5, wherein a (meth)acrylate monomer as the polymerizable low molecular weight compound is used.

8. The method according to claim 5, wherein ethylene dimethacrylate as the low molecular weight compound functioning as crosslinking agent is included.

9. The method according to claim 3, wherein the solid electrolyte is prepared, by dissolving a low molecular weight compound that is polymerizable by using heat, an optical polymerization initiator or the like in the electrolyte solution in advance, and subjecting the resultant solution to polymerization reaction to form a crosslinked polymer.

10. The method according to claim 9, wherein the degree of crosslinking of the crosslinked polymer is controlled by a combination of a low molecular weight compound having a single reaction point and a low molecular weight compound, which functions as a crosslinking agent, having two or more reaction points.

11. The method according to claim 10, wherein a homopolymer of the low molecular weight compound having a single reaction point contains a low molecular weight compound that is soluble in the electrolyte solution.

12. The method according to claim 9, wherein a (meth)acrylate monomer as the polymerizable low molecular weight compound is used.

13. The method according to claim 10, wherein ethylene dimethacrylate as the low molecular weight compound functioning as the crosslinking agent is included.

14. A nonaqueous secondary battery comprising the solid electrolyte according to claim 1.

15. The nonaqueous secondary battery according to claim 14, wherein the electrolyte solution phase included in the phase-separated structure of the solid electrolyte has a size of less than 20 μm.

16. A method of producing a nonaqueous secondary battery, comprising the steps of: assembling a negative electrode, a positive electrode and a separator into a final battery form, and performing the method of producing the solid electrolyte according to claim 3.

17. The method according to claim 16, wherein in the step of performing the method of producing the solid electrolyte, the solid electrolyte is prepared, by dissolving a low molecular weight compound that is polymerizable by using heat, an optical polymerization initiator or the like in the electrolyte solution in advance, and subjecting the resultant solution to polymerization reaction to form a crosslinked polymer.

18. The method according to claim 17, wherein the degree of crosslinking of the crosslinked polymer is controlled by a combination of a low molecular weight compound having a single reaction point and a low molecular weight compound, which functions as a crosslinking agent, having two or more reaction points.

19. The method according to claim 18, wherein a homopolymer of the low molecular weight compound having a single reaction point contains a low molecular weight compound that is soluble in the electrolyte solution.

20. The method according to claim 17, wherein a (meth)acrylate monomer as the polymerizable low molecular weight compound is used.

21. The method according to claim 18, wherein ethylene dimethacrylate as the low molecular weight compound functioning as crosslinking agent is included.
